(19) United States
(12) Patent Application Publication
(10) Pub. No.: US 2005/0179535 A1
(43) Pub. Date: Aug. 18, 2005

(54) Break signalling method in motor vehicles and break signalling unit

(76) Inventor: Jacek Pilat, Wroclaw (PL)

Correspondence Address: JACEK PILAT, 9320 WALKER ST, PHILADELPHIA, PA, 19114, US

(21) Appl. No.: 11/097,755

(22) Filed: Apr. 4, 2005

(30) Foreign Application Priority Data
Oct. 20, 2003 (WO) PCT/PL03/00109

(51) Int. Cl. B60Q 1/44

(52) U.S. Cl. 340/479; 340/476

(57) ABSTRACT

The method in which a sensor monitors the proximity, location of the driver's foot in relation to the break pedal and acceleration pedal and after processing, send a signal to an additional break light system. In an advantageous embodiment of the present invention for monitoring and reading the position of the driver's foot in relation to the break and accelerator pedals, a proximity sensor is used which emits a beam of visible or IR light directed at the immediate area surrounding the two pedals. The signal, after bouncing off the object is converted into an electrical signal. Depending on the position of the object being monitored, the amplified output signal from the sensor after having exceeded a predetermined value, activates the external break light warning system. According to the present invention, the break signalling unit constitutes an additional equipment of a motor vehicle and is provided with the proximity sensor (1) located in the driver's cab, relay module (2), and an external light signalling system (3) where the electrical impulse generated in the sensor module controls, after being amplified, activates the external break light warning system.

The subject of the present invention relates to break signalling method in motor vehicles and break signalling unit, especially in passenger cars, designed to warn other road users of the driver's intention to break.

Known technologies of the system employ the stop lights, which are illuminated once the break pedal is depressed by the driver. In passenger cars, the stop lights are usually activated by a micro-switch of which one terminal is in constant contact with the break pedal lever, which equals to an open circuit state. Depressing the break pedal releases the retracting spring, which moves the terminal inside the housing of the switch thus closing the electrical circuit and in effect activating the stop lights. Also, known are systems in which depressing the break pedal causes pressure increase in the hydraulic breaking system of a vehicle; the increase in the pressure activates a sensor that in turn closes electrical contacts. The description of Polish patent application no. P.325615 proposes the system in which a vehicle is equipped with additional stop lights, preferably two red stop lights, located on the wind shield of the vehicle or in the front bumper and synchronized with the standard rear stop lights. Also, in Polish patent PL 164389, a system is proposed in which break signaling unit warning other road users of a considerable and fast deceleration of a vehicle has the form of a bearing-seated roller which center of gravity is situated below its axis of rotation. On its surface the roller is covered with geometrical patterns of contrasting colors, e.g. horizontal stripes.

So far, all the break systems used in today's vehicles have failed to warn other motorists about the “intention” of the driver to break. The time from the moment the decision to break is made to the moment when the break pedal is actually depressed and the stop lights are activated is long enough for potential rearing to occur. Driving a car on public roads without the possibility to inform other motorists of the intention to break may be and often is the cause of many car collisions.

A standard breaking system is a circuit consisting of wires, fuses, switches, and lamps.

The uniqueness of the solution according to the invention is in the idea of such a method, that a sensor monitors and recognites a presence of driver's foot in direct proximity of the break pedal and the acceleration pedal, and the electric sygnal from the sensor, after being processed, operates an additional light signalling unit.

The most preferable design of such a break signalling method would consist of light emitter, visible or IR, that would direct the light beam into the immediate area of the break and acceleration pedals and after bouncing off the objects it would be converted into an electrical signal. Depending on the position of the object in relation to the pedals being monitored, the amplified output signal from the sensor unit would activate the break warning lights.

The break signalling unit design stipulates that the monitoring system is an additional accessory installed in a vehicle and that it contains proximity sensor located in the driver's cab, a relay system, and a light signals system wherein the electrical signal generated in the sensor unit will control the activation of the light signalling system.

The proximity sensor of the break signalling unit would preferably contain at least one rebound photo-switch. The electrical signal from the proximity sensor is fed into the relay element and then to the signalling unit which is equipped with a set of LEDs preferably located within the center of the standard STOP light.

According to the invention the break signalling unit contains a proximity sensor which is installed in the driver's cab and it monitors the immediate area surrounding the break and acceleration pedals as well as the proximity of the driver's foot to said pedals. The signal monitoring the increasing distance between the driver's foot and the acceleration pedal with simultaneously increasing proximity of his foot to the break pedal suggests a very high probability of his intention to break and, after having been converted to an electrical signal, it activates the stop lights unit mounted in the rear of the vehicle.

The idea here is an “early warning” signal which is being activated even before the actual breaking maneuver is executed. It guarantees that the car driving behind will receive an early warning about the possibility of breaking action about to be executed by the driver before him and at the same time it will ensure that the driver behind will not accelerate thus reducing the possibility of a potential accident.

The subject of invention is explained on example of realization in two figures—

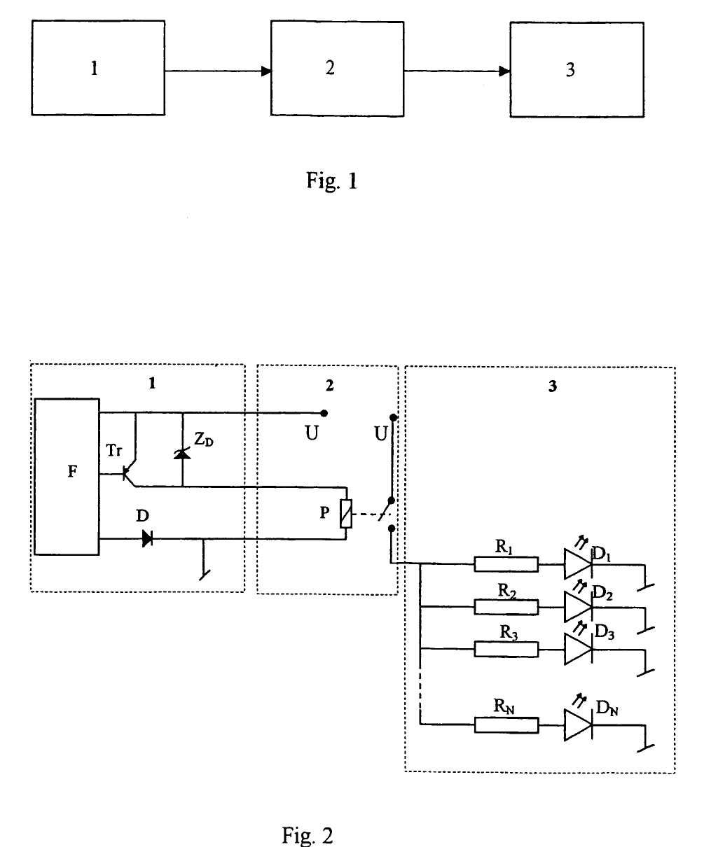

FIG. 1 is a block diagram of the signal generator and

FIG. 2 is its schematic diagram.

### EXAMPLE 1

Break signalling unit is equipped with the proximity sensor 1 which employs a rebound photo-switch to read the location of the driver's foot. The opto-electric element F of the unit is located inn the driver's cab. The photo-switch operating in a triangulation mode sends a light beam through a lens directed onto the immediate area surrounding the break and gas pedals. Part of the light beam bounces off the object and is directed to the radiation detector where it is converted into an electrical signal and amplified in the circuit consisting of transistor Tr, rectifying diode D, and voltage regulator diode Zd (Zener diode). After being converted into an electrical signal and amplified in the sensor's system, an electrical impulse is received at the photo-switch outlet the value of which depends on the location of the monitored object and which strength is sufficient to control the relay circuit. After a predefined value of the impulse is exceeded, the relay unit P activates the light signaling system 3 consisting of 24 LEDs D1, D2, D3, . . . D24. The diodes are connected in-parallel through resistors R1, R2, R3, . . . R24 located within the field of the STOP light.

### EXAMPLE II

Break signalling unit is equipped as in Example I with the exception that an IR light is emitted by the laser diode and the light signalling unit is located within the central STOP light and is equipped with 28 LEDs D1, D2, D3, . . . D28 connected in-parallel through one resistor controlling the signal passing through LEDs.

1. A break signalling method in a motor vehicle equipped with breaking line, distinguished by external light signalling circuit wherein a proximity sensor reads the location of the driver's foot in relation to the break and accelerator pedals where the electrical impulse received from the sensor, after being converted, activates an additional break light system.

2. The method, according to claim 1, wherein the location of the driver's foot is monitored by emitting a beam of a visible light directed onto the immediate area surrounding the break and accelerator pedals which, after bouncing off the object, is converted into an electrical signal.

3. The method according to claim 1, wherein the proximity of the driver's foot is monitored by emitting a beam of IR light.

4. The break signalling unit, an additional device installed in cars equipped in breaking line and external break lights system, distinguished by proximity sensor (1) located in the driver's cab, relay module (2), and external light system (3); the electrical impulse generated in the sensor module (1) controls the additional break light system.

5. The break signalling unit, according to claim 4 wherein proximity sensor (1) is equipped with a rebound photo-switch.

6. The break signalling unit, according to claim 5 wherein the proximity sensor (1) is equipped with a laser diode acting as the source of light emission.

7. The break signalling unit, according to claim 4, wherein break light system (3) is equipped with a set of light emitting diodes (D_{1-N}) located within the field of the STOP lights.

8. The break signalling unit, according to claim 7, wherein the set of light emitting diodes (D_{1-N}) is located along the peripheral of the central STOP light.
